(19) United States
(12) Patent Application Publication
(10) Pub. No.: US 2026/0297254 A1
(43) Pub. Date: Oct. 1, 2026

(54) THERMOSETTING RESIN COMPOSITION, A MANUFACTURING METHOD THEREFOR, AND A COMPOSITE COMPRISING THE SAME

(71) Applicants: HYUNDAI MOTOR COMPANY, Seoul (KR); KIA CORPORATION, Seoul (KR); Research & Business Foundation SUNGKYUNKWAN UNIVERSITY, Suwon-si (KR)

(72) Inventors: Jonggeun Sung, Hwaseong-si (KR); Da Bin Kim, Hwaseong-si (KR); SungWan Jeon, Hwaseong-si (KR); Yongseok Jeong, Suwon-si (KR); Jeongwoo Han, Daejeon (KR); Changsik Song, Seoul (KR)

(73) Assignees: HYUNDAI MOTOR COMPANY, Seoul (KR); KIA CORPORATION, Seoul (KR); Research & Business Foundation SUNGKYUNKWAN UNIVERSITY, Suwon-si (KR)

(21) Appl. No.: 19/272,627

(22) Filed: Jul. 17, 2025

(30) Foreign Application Priority Data
Mar. 28, 2025 (KR) 10-2025-0040356

(51) Int. Cl. C08G 65/42; C08K 3/04

(52) U.S. Cl. CPC C08G 65/42; C08K 3/046

(57) ABSTRACT

A thermosetting resin composition includes a manufacturing method, and a composite comprising the same. The thermosetting resin composition may exhibit properties such as degradability, reprocessability, remoldability, and self-healing capability. When used as a matrix resin in a carbon fiber-reinforced composite, the thermosetting resin composition may enable recovery of fibers having the quality and performance of virgin fibers through post-use decomposition, and may exhibit improved heat resistance and mechanical properties compared to commercially available resin-based composites.

### CROSS-REFERENCE TO RELATED APPLICATION

This present application claims the benefit of and priority to Korean Patent Application No. 10-2025-0040356, filed on Mar. 28, 2025, in the Korean Intellectual Property Office, the entire disclosure of which is incorporated herein by reference.

### FIELD

The present disclosure relates to a thermosetting resin composition, a manufacturing method therefor, and a composite comprising the same.

### BACKGROUND

Thermosetting resins are widely used as matrix resins for fiber-reinforced composites due to their excellent mechanical properties, heat/chemical resistance, and high fiber impregnation capability compared to thermoplastic resins. However, fully cured thermosetting resins are difficult to process, mold, repair, or chemically decompose by heat, making them difficult to reprocess, remold, and recycle, which is a disadvantage for environmentally friendly materials.

To address this, epoxy resin compositions designed for easy chemical decomposition have been developed and commercialized under names such as “recyclable epoxy resin.” However, these decomposable epoxy resins only enable recycling by dissolving discarded composites in solvents to obtain a mixture of fibers and oligomer-form resin, limiting the obtainable valuable recyclable materials to separated fibers, and these separated fibers have lower quality and performance compared to virgin fibers.

The matters described in this Background section are only for enhancement of understanding of the background of the disclosure, and should not be taken as acknowledgement that they correspond to prior art already known to those having ordinary skill in the art.

### SUMMARY

The following summary presents a simplified summary of certain features. The summary is not an extensive overview and is not intended to identify key or critical elements.

The present disclosure is directed to providing a thermosetting resin composition that, when used as a matrix resin for a carbon fiber reinforced composite, may not only enable fiber recycling through decomposition of the matrix, but also imparts renewed commercial value to the post-use composite through reprocessing, remolding, and self-healing.

The present disclosure is further directed to providing a thermosetting resin composition that exhibits improved mechanical properties while also having the aforementioned additional functionalities.

The present disclosure is further directed to providing a thermosetting resin composition that can be applied to green technology fields, such as environmentally friendly vehicles.

An aspect of the present disclosure may provide a thermosetting resin composition including a polymer formed by reacting an epoxy resin, an amine-based compound, and a crosslinking agent, wherein the epoxy resin is represented by Chemical Formula 1, the amine-based compound includes at least one primary amine group, and the crosslinking agent includes an acrylate-based compound, a vinyl-based compound, or any combination thereof.

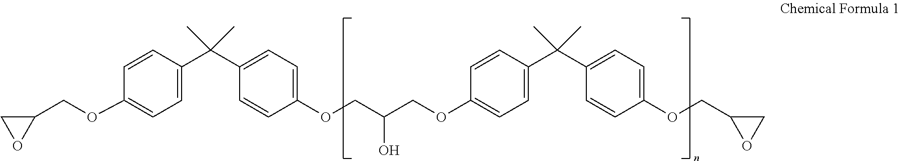

In Chemical Formula 1, n may represent an average number of repeating units and may satisfy 0<n≤0.6.

According to an embodiment of the present disclosure, the amine-based compound may include 4,4′-methylene bis(2-methylcyclohexylamine), 4,4′-methylene bis(cyclohexylamine), diethylene triamine, isophorone diamine, 4,4′-diaminophenylsulfone, diethyltoluene diamine, triethylene tetramine, dicyandiamide, or any combination thereof.

According to an embodiment of the present disclosure, the acrylate-based compound may be represented by Chemical Formula 2 below.

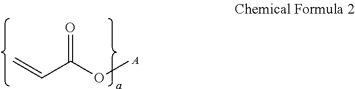

In Chemical Formula 2, A may be a substituted or unsubstituted C1-C10 linear alkyl group or a substituted or unsubstituted C3-C10 branched alkyl group, a substituted or unsubstituted C2-C10 linear alkyl group including an ether group or a substituted or unsubstituted C3-C10 branched alkyl group including an ether group, a substituted or unsubstituted C3-C10 cyclic alkyl group, a substituted or unsubstituted C6-C20 aryl group, or any combination thereof, and a may be in a range of from 2 to 10.

According to an embodiment of the present disclosure, the vinyl-based compound may be represented by Chemical Formula 3 below.

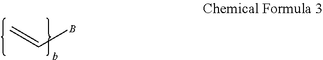

In Chemical Formula 3, B may be a substituted or unsubstituted C1-C10 linear alkyl group or a substituted or unsubstituted C3-C10 branched alkyl group, a substituted or unsubstituted C2-C10 linear alkyl group including an ether group or a substituted or unsubstituted C3-C10 branched alkyl group including an ether group, a substituted or unsubstituted C3-C10 cyclic alkyl group, a substituted or unsubstituted C6-C20 aryl group, a sulfone group, a sulfonate group, a sulfide group, or any combination thereof, and b may be in a range of from 2 to 10.

According to an embodiment of the present disclosure, the polymer may be formed by reacting the epoxy resin, the amine-based compound, and the crosslinking agent in a molar ratio in a range of 1:(0.5 to 2):(0.3 to 2).

According to an embodiment of the present disclosure, the polymer may include a crosslinked network.

According to an embodiment of the present disclosure, the formation and decomposition of the crosslinked network may be reversible.

According to an embodiment of the present disclosure, the thermosetting resin composition may have a stress relaxation time (RT180° C.) at 180° C. of 3000 seconds or less.

According to an embodiment of the present disclosure, the thermosetting resin composition may have a glass transition temperature (Tg) of 50° C. or higher.

Another aspect of the present disclosure may provide a method for manufacturing a thermosetting resin composition, the method including preparing a mixture by mixing an epoxy resin and a crosslinking agent, and adding an amine-based compound to the mixture.

According to an embodiment of the present disclosure, the adding may include adding the amine-based compound to the mixture in a single addition or in a plurality of additions.

Still another aspect of the present disclosure may provide a carbon fiber reinforced composite comprising the thermosetting resin composition and carbon fibers.

The thermosetting resin composition of the present disclosure may exhibit properties such as degradability, reprocessability, remoldability, and self-healing capability.

When the thermosetting resin composition of the present disclosure is used as a matrix resin in a carbon fiber-reinforced composite, fibers having quality and performance at the level of virgin fibers may be recovered through post-use decomposition.

When the thermosetting resin composition of the present disclosure is used as a matrix resin in a carbon fiber-reinforced composite, it may exhibit improved heat resistance and mechanical properties compared to commercially available resin-based composites.

Effects of the present disclosure are not limited to the above-mentioned effects, and other effects, not mentioned above, should be clearly understood by those having ordinary skill in the art from the following description.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a diagram showing dynamic crosslinking behavior of a polymer according to an embodiment of the present disclosure.

FIG. 2 shows experimental results of evaluating a self-healing performance of resin compositions according to examples and comparative examples of the present disclosure.

FIG. 3 shows experimental results of evaluating decomposability of resin compositions according to examples and comparative examples of the present disclosure.

FIG. 4 shows SEM images of a carbon fiber fabric surface before and after decomposition of a carbon fiber reinforced composite according to an embodiment of the present disclosure.

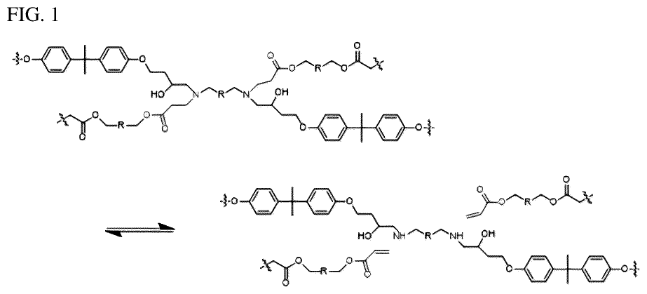

### DETAILED DESCRIPTION

Hereinafter, the present disclosure is described in more detail. However, the following embodiments are provided merely as references for describing the present disclosure in detail, and the present disclosure is not limited thereto and may be implemented in various forms.

Unless otherwise defined, all technical and scientific terms used herein have the same meaning as commonly understood by those having ordinary skill in the art to which the present disclosure pertains.

The terms used herein are intended merely to describe particular embodiments effectively and are not intended to limit the present disclosure.

Singular forms “a,” “an,” and “the” used in the specification and the appended claims are intended to include plural referents unless the context clearly dictates otherwise.

The units used in this specification, unless otherwise stated, are based on weight. For instance, the units such as “%” or “ratio” refer to weight percent (wt. %) or weight ratio, respectively. Unless otherwise defined, weight percent (wt. %) refers to the proportion of a specific component within the total composition, expressed as a percentage by weight.

When a portion is described as “including” or “comprising” a certain component, it means that, unless specifically stated to the contrary, the inclusion of other components is not excluded but rather that additional components may also be included.

In addition, numerical ranges used in this specification may include all values between the lower and upper limits, all values incrementally derived logically within shape and breadth of the defined ranges, all double-limited values, and all possible combinations of upper and lower limits of differently limited numerical ranges. Unless specifically defined in the specification of the present disclosure, values outside the defined numerical ranges that may occur due to experimental error or rounding off of values are also included within the defined numerical ranges.

The following provides a more detailed description of the present disclosure.

The present disclosure provides a thermosetting resin composition comprising a polymer formed by reacting an epoxy resin, an amine-based compound, and a crosslinking agent.

In an embodiment of the present disclosure, the epoxy resin may be represented by Chemical Formula 1 below.

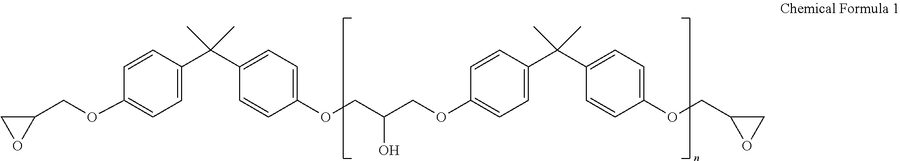

In Chemical Formula 1, n represents the average number of repeating units, and may satisfy 0<n≤0.6, 0<n≤0.45, or 0<n≤0.3. When satisfying this range, the epoxy resin may exhibit a viscosity suitable for manufacturing and using as a matrix resin for carbon fiber reinforced composites.

In an embodiment of the present disclosure, the amine-based compound may include at least one primary amine group, specifically two or more primary amine groups, and as an upper limit, may include up to ten primary amine groups.

In an embodiment of the present disclosure, the amine-based compound may include 4,4′-methylene bis(2-methylcyclohexylamine), 4,4′-methylene bis(cyclohexylamine), diethylene triamine, isophorone diamine, 4,4′-diaminophenylsulfone, diethyltoluene diamine, triethylene tetramine, dicyandiamide, or any combination thereof.

In an embodiment of the present disclosure, the crosslinking agent may include an acrylate-based compound, a vinyl-based compound, or any combination thereof.

In an embodiment of the present disclosure, the acrylate-based compound may be represented by Chemical Formula 2 below.

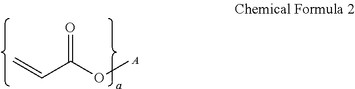

In an embodiment of the present disclosure, in Chemical Formula 2, A may be a substituted or unsubstituted C1-C10 linear alkyl group or a substituted or unsubstituted C3-C10 branched alkyl group, a substituted or unsubstituted C2-C10 linear alkyl group comprising an ether group or a substituted or unsubstituted C3-C10 branched alkyl group comprising an ether group, a substituted or unsubstituted C3-C10 cyclic alkyl group, a substituted or unsubstituted C6-C20 aryl group, or any combination thereof, and a may be in a range of from 2 to 10. The acrylate-based compound may be hexanediol diacrylate, trimethylolpropane triacrylate, or any combination thereof; however, it is not limited thereto as long as the objectives of the present disclosure can be achieved.

In an embodiment of the present disclosure, the vinyl-based compound may be represented by Chemical Formula 3 below.

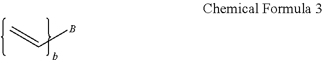

In an embodiment of the present disclosure, in Chemical Formula 3, B may be a substituted or unsubstituted C1-C10 linear alkyl group or a substituted or unsubstituted C3-C10 branched alkyl group, a substituted or unsubstituted C2-C10 linear alkyl group including an ether group or a substituted or unsubstituted C3-C10 branched alkyl group including an ether group, a substituted or unsubstituted C3-C10 cyclic alkyl group, a substituted or unsubstituted C6-C20 aryl group, a sulfone group, a sulfonate group, a sulfide group, or any combination thereof, and b may be in a range of from 2 to 10. The vinyl-based compound may be divinyl sulfone, but is not limited thereto as long as the objectives of the present disclosure can be achieved.

In an embodiment of the present disclosure, the polymer may be formed by reacting the epoxy resin, the amine-based compound, and the crosslinking agent in a molar ratio in a range of 1:(0.5 to 2):(0.3 to 2), 1:(0.6 to 1.5):(0.4 to 1.5), or 1:(0.8 to 1.2):(0.6 to 1).

In an embodiment of the present disclosure, the polymer may include a crosslinked network.

In an embodiment of the present disclosure, the formation and decomposition of the crosslinked network may be reversible. Thermosetting polymers are highly stable but irreversible, making reprocessing and remolding difficult. However, a thermosetting polymer including a crosslinked network that is reversibly formable and decomposable (hereinafter, “dynamic crosslinks”) may break and reform under specific conditions such as temperature, pH, or catalyst. Therefore, the thermosetting resin composition of the present disclosure, despite being thermosetting, may allow reprocessing or remolding under suitable conditions by readjusting the dynamic crosslinks.

In an embodiment of the present disclosure, the thermosetting resin composition may have a stress relaxation time (RT180° C.) at 180° C. of 3000 seconds or less, specifically 2500 seconds or less, more specifically 2000 seconds or less. Due to the dynamic crosslinks formed in the polymer, the stress gradually relaxes at constant deformation, resulting in the aforementioned stress relaxation time.

In an embodiment of the present disclosure, the thermosetting resin composition may have a glass transition temperature (Tg) of 50° C. or higher, 70° C. or higher, 100° C. or higher, 120° C. or higher, 140° C. or higher, and as an upper limit, up to 300° C. When satisfying this range, the thermosetting resin composition may maintain high rigidity despite a fast behavior change rate.

Another aspect of the present disclosure may provide a method for manufacturing a thermosetting resin composition, the method including preparing a mixture by mixing an epoxy resin and a crosslinking agent, and adding an amine-based compound to the mixture.

Preparing the mixture may include first mixing the epoxy resin and the crosslinking agent to prepare the mixture. By mixing the epoxy resin with the less reactive crosslinking agent first, the crosslinking agent may be uniformly dispersed. Uniform dispersion of the crosslinking agent may prevent local overreaction, reduce mixing defects caused by viscosity inconsistency, and prevent degradation of final physical properties due to partial curing, thereby providing excellent workability.

The adding may include adding the amine-based compound to the mixture prepared by first mixing the epoxy resin and the crosslinking agent.

In an embodiment of the present disclosure, the adding may include adding the amine-based compound to the mixture in a single addition or in a plurality of additions. Whether to add the amine-based compound in a single addition or a plurality of additions may be selected based on the reactivity of the amine-based compound. When the reactivity is relatively low, the compound may all be added in a single addition, and when relatively high, it may be added in a plurality of additions.

Another aspect of the present disclosure may provide a carbon fiber reinforced composite (CFRP) including the thermosetting resin composition and carbon fibers.

The carbon fiber reinforced composite may be obtained by impregnating carbon fibers with the thermosetting resin composition and then curing the composition. The CFRP may further include reinforcing fibers or foam in addition to the thermosetting resin composition and carbon fibers.

In an embodiment of the present disclosure, the carbon fibers may be prepared using raw materials such as rayon or polyacrylonitrile (PAN), or they may be prepared by spinning raw materials such as petroleum or coal pitch. Recycled carbon fibers from carbon fiber trimmings or from CFRP after removing the resin may also be used. The form of the carbon fibers may be, for example, monofilament or multifilament arranged in one direction or alternately crossed, woven fabrics, non-woven fabrics, or mats. Among these, monofilament, woven fabric, non-woven fabric, or mat are advantageous, and woven fabric is advantageous.

In an embodiment of the present disclosure, the average fiber diameter of the carbon fibers may be in a range of 1-100 μm. Within this range, the fiber is easy to process and provides improved tensile properties in the resulting CFRP. The average fiber diameter may be measured by observation using a scanning electron microscope (SEM) or the like. The length of 50 or more fibers may be randomly selected and measured, and the number-average diameter may calculated. The fineness of the carbon fibers may be 20 to 4,500 tex. Within this range, impregnation with the thermosetting resin composition is easy and the resulting composite may exhibit improved tensile strength. The fineness may be determined by finding the weight of an arbitrary length of long fibers and converting it to weight per 1,000 m. The number of filaments may be about 500 to 60,000.

The method for preparing the carbon fiber-reinforced composite of the present disclosure is not particularly limited, but it is advantageous to mix the mixture of the epoxy resin and the crosslinking agent with the amine-based compound immediately before molding, and then perform impregnation and curing of the carbon fibers, within 10 minutes, or within 5 minutes. From this perspective, the method may include molding processes such as low-pressure RTM (resin transfer molding), medium-pressure RTM, high-pressure RTM, compression RTM, liquid compression molding, liquid laydown, spray laydown, surface RTM, prepreg compression molding, or liquid cast molding, but is not limited thereto.

When the CFRP includes foam in addition to the thermosetting resin composition and carbon fibers, the CFRP may be manufactured in the same manner as described above by placing carbon fibers and the foaming agent in the mold. In the molding of CFRP, the temperature for injecting the thermosetting resin composition into the mold or impregnating the carbon fibers may be in a range of 30 to 150° C. The impregnation time may be in a range of 0.1 to 15 minutes, 0.2 to 10 minutes, or 0.5 to 5 minutes, from the perspective of moldability and productivity. The curing temperature may be in a range of 50 to 200° C., 80 to 150° C., or 100 to 150° C. The curing time may be in a range of 0.1 to 15 minutes, 0.2 to 10 minutes, or 0.5 to 5 minutes, from the perspective of moldability and productivity. The carbon fiber reinforced composite of the present disclosure may be used as automotive structural materials or building materials. Examples of automotive structural materials may include bumpers, spoilers, cowlings, front grilles, garnishes, bonnets, trunk lids, fender panels, door panels, roof panels, instrument panels, door trims, quarter trims, roof linings, pillar garnishes, deck trims, tonneau boards, package trays, dashboards, console boxes, kicking plates, switch bases, seat back boards, seat frames, armrests, sun visors, intake manifolds, engine head covers, engine under covers, and oil filter housings.

Hereinafter, examples of the present disclosure and comparative examples are described. However, the following examples are examples of the present disclosure, and the present disclosure is not intended to be limited thereto.

### Example 1

An epoxy resin with an epoxy equivalent of 170 g/equivalent (KDS-8128, Kukdo Chemical Co., Ltd.) was mixed with divinyl sulfone and stirred at room temperature for 10 minutes to prepare a mixture. The molar ratio of the epoxy resin to divinyl sulfone was 1:1. 4,4′-methylene bis(2-methylcyclohexylamine) in an equal molar amount to the divinyl sulfone was added to the mixture and stirred at room temperature for 10 minutes to induce crosslinking, thereby preparing a thermosetting resin composition.

### Examples 2 to 18 and Comparative Examples 1 to 6

The same procedure as Example 1 was carried out, except that the type and amount of the amine-based compound and the crosslinking agent were set as shown in Table 1 below.

TABLE 1

| | Epoxy Resin | Amine-based | | | | Crosslinking | | |
|---|---|---|---|---|---|---|---|---|
| | (eq) | Compound (eq) | | | | Agent (eq) | | |
| | DGEBA | MBMCA | MBCA | IPDA | DETA | DVS | HDDA | |
| Example 1 | 1 | 1 | — | — | — | 1 | — | — |
| Example 2 | 1 | 1 | — | — | — | — | 1 | — |
| Example 3 | 1 | 1 | — | — | — | — | — | 0.67 |
| Example 4 | 1 | 0.8 | — | — | — | 1 | — | — |
| Example 5 | 1 | 0.8 | — | — | — | — | 1 | — |
| Example 6 | 1 | 0.8 | — | — | — | — | — | 0.67 |
| Example 7 | 1 | 1.2 | — | — | — | 1 | — | — |
| Example 8 | 1 | 1.2 | — | — | — | — | 1 | — |
| Example 9 | 1 | 1.2 | — | — | — | — | — | 0.67 |
| Example 10 | 1 | — | 1 | — | — | 1 | — | — |
| Example 11 | 1 | — | 1 | — | — | — | 1 | — |
| Example 12 | 1 | — | 1 | — | — | — | — | 0.67 |
| Example 13 | 1 | — | — | 1 | — | 1 | — | — |
| Example 14 | 1 | — | — | 1 | — | — | 1 | — |
| Example 15 | 1 | — | — | 1 | — | — | — | 0.67 |
| Example 16 | 1 | — | — | — | 1 | 1 | — | 1 |
| Example 17 | 1 | — | — | — | 1 | — | 1 | — |
| Example 18 | 1 | — | — | — | 1 | — | — | 0.67 |
| Comparative | 1 | 0.4 | — | — | — | — | — | — |
| Example 1 | | | | | | | | |
| Comparative | 1 | 0.5 | — | — | — | — | — | — |
| Example 2 | | | | | | | | |
| Comparative | 1 | 0.6 | — | — | — | — | — | — |
| Example 3 | | | | | | | | |
| Comparative | 1 | — | 0.5 | — | — | — | — | — |
| Example 4 | | | | | | | | |
| Comparative | 1 | — | — | 0.5 | — | — | — | — |
| Example 5 | | | | | | | | |
| Comparative | 1 | — | — | — | 0.5 | — | — | — |
| Example 6 | | | | | | | | |

DGEBA: Diglycidyl Ether of Bisphenol A
MBMCA: 4,4′-Methylene bis (2-methylcyclohexylamine)
MBCA: 4,4′-Methylene bis (cyclohexylamine)
IPDA: Isophorone Diamine
DETA : Diethylene Triamine
DVS : Divinyl Sulfone
HDDA : Hexanediol Diacrylate
TMPTA: Trimethylolpropane Triacrylate

### Example 19

The thermosetting resin composition of Example 1 was impregnated into Zoltek's T300 grade unidirectional fabric (200 gsm) using a hand layup/vacuum bagging process and then thermally molded (150° C., 4 hours) to prepare a carbon fiber reinforced composite.

### Example 20

The same procedure as Example 19 was carried out, except that the thermosetting resin composition of Example 2 was used.

### Example 21

The same procedure as Example 19 was carried out, except that the thermosetting resin composition of Example 3 was used.

### Example 22

The same procedure as Example 19 was carried out, except that the thermosetting resin composition of Example 10 was used.

### Example 23

The same procedure as Example 19 was carried out, except that the thermosetting resin composition of Example 11 was used.

### Comparative Example 7

A carbon fiber-reinforced composite was prepared by impregnating Zoltek's T300 grade unidirectional fabric (200 gsm) with a commercial epoxy resin composition (KFR160: KFH163, Kukdo Chemical) using a resin infusion process, followed by thermal molding at room temperature for 24 hours and 80° C. for 2 hours.

### Experimental Example 1: Verification of Dynamic Crosslinking Reaction

To verify the presence of dynamic crosslinking reactions in the resin compositions prepared according to the examples and comparative examples, the stress relaxation time was measured. Specifically, the stress relaxation time was measured by applying a force of 5N at a temperature of 180° C. using a rotational rheometer, maintaining a strain of 1%, and determining the time when G/Gₒ=1/e (approximately 36.8%), and the results are shown in Table 2. G is the shear modulus, and Gₒ is the initial modulus.

TABLE 2

| | Stress Relaxation | Presence of Dynamic |
|---|---|---|
| | Time (seconds) | Crosslinking Reaction |
| Example 1 | 922 | O |
| Example 2 | 844 | O |
| Example 3 | 1571 | O |
| Example 4 | 1375 | O |
| Example 5 | 1314 | O |
| Example 6 | 2467 | O |
| Example 7 | 548 | O |
| Example 8 | 471 | O |
| Example 9 | 843 | O |
| Example 10 | 521 | O |
| Example 11 | 473 | O |
| Example 12 | 962 | O |
| Example 13 | 803 | O |
| Example 14 | 694 | O |
| Example 15 | 1349 | O |
| Example 16 | 1152 | O |
| Example 17 | 1128 | O |
| Example 18 | 1964 | O |
| Comparative Example 1 | — | X |
| Comparative Example 2 | — | X |
| Comparative Example 3 | — | X |
| Comparative Example 4 | — | X |
| Comparative Example 5 | — | X |
| Comparative Example 6 | — | X |

As can be seen from Table 2 above, Comparative Examples 1 to 6 have no measurable stress relaxation time, confirming that the crosslinking agent of the present disclosure must be included for dynamic crosslinking reactions to occur.

Additionally, it was observed that Examples 4 to 6, which used lower equivalents of amine-based compound, showed longer stress relaxation times than Examples 1 to 3 and 7 to 9, indicating that an increased number of amine-crosslinker bonds leads to more dynamic crosslink formation. In addition, it was confirmed that when different types of amine-based compounds according to the present disclosure were used, all showed stress relaxation times within 2000 seconds, indicating that dynamic crosslinks form smoothly.

### Experimental Example 2: Tg Measurement

The glass transition temperatures of the resin compositions prepared according to the examples and comparative examples were measured. The glass transition temperature may be measured using a dynamic mechanical analysis (DMA) device. Specifically, using Mettler Toledo's DMA 1 equipment, the point where (E″/E′=tan δ) reaches its maximum value was measured with a heating rate of 3° C./min and a measurement frequency of 1 Hz, and the results are shown in Table 3.

TABLE 3

| | Tg |
|---|---|
| | (° C.) |
| Example 1 | 142 |
| Example 2 | 60 |
| Example 3 | 127 |
| Example 4 | 136 |
| Example 5 | 55 |
| Example 6 | 120 |
| Example 7 | 130 |
| Example 8 | 52 |
| Example 9 | 114 |
| Example 10 | 144 |
| Example 11 | 64 |
| Example 12 | 122 |
| Example 13 | 148 |
| Example 14 | 70 |
| Example 15 | 123 |
| Example 16 | 128 |
| Example 17 | 56 |
| Example 18 | 109 |
| Comparative Example 1 | 140 |
| Comparative Example 2 | 166 |
| Comparative Example 3 | 138 |
| Comparative Example 4 | 168 |
| Comparative Example 5 | 162 |
| Comparative Example 6 | 151 |

As can be seen in Table 3, it was confirmed through Examples 1 and 2 that lower rotational ability of the central element results in a relatively higher glass transition temperature. Also, through Example 3, it can be seen that when there are more functional groups, the crosslink density is improved, resulting in higher glass transition temperature even with fewer equivalents.

From Examples 4 to 6, which used a relatively smaller amount of amine-based compound, it can be seen that when there are fewer amine groups, the overall crosslink density decreases and bonding between epoxy resins is induced, decreasing the glass transition temperature. Through Examples 7 to 9, which used a relatively larger amount of amine-based compound, it was confirmed that although the crosslink density is improved, unreacted amine groups act as entanglements inducing chemical structural pores, thus decreasing the glass transition temperature.

It was confirmed that similar trends were observed when using different types of amine-based compounds according to the present disclosure.

Through this, it can be seen that the thermosetting resin composition according to the present disclosure can adjust the glass transition temperature of the composition according to the type and ratio of the amine-based compound and crosslinking agent, making it applicable to various fields such as adhesives, pressure-sensitive adhesives, coatings, paints, printed circuit boards, and the like, where general thermosetting resins are used.

### Experimental Example 3: Evaluation of Composite Properties

The properties of carbon fiber reinforced composites manufactured from resin compositions according to the examples and comparative examples of the present disclosure were evaluated. Specimens were prepared by impregnating and laminating 4-5 layers of carbon fiber fabric with the resin composition to a thickness of about 1.5 mm (resin content 50-60%), and the properties were measured by the methods as described below, with the results shown in Table 4.

### Physical Property Measurement Methods:

(1) Tensile strength and Tensile Modulus: Evaluated according to ASTM D3039, with normalized values assuming 55% fiber volume fraction also shown.

(2) Tensile Elongation: Evaluated using specimens according to ASTM D3039 standard measurement.

(3) E′ Onset Temperature and Tan δ peak: Dynamic Mechanical Analysis (DMA) (dual cantilever mode, 10 Hz with 10 μm amplitude, 3° C./min heating condition).

TABLE 4

| | Tensile: | | | T_{g} | |
|---|---|---|---|---|---|
| | Strength (MPa) | Modulus (GPa) | Elongation | E′ Onset | Tanδ |
| | [normalized] | [normalized] | (%) | (° C.) | (° C.) |
| Comparative Example 7 | 941.6 | 65.0 | 1.4 | 96.0 | 109.3 |
| | [1590.0] | [109.8] | | | |
| Example 19 | 876 | 58.4 | 1.4 | 155.9 | 170.9 |
| | [1682] | 112.2. | | | |
| Example 20 | 927 | 65.9 | 1.3 | 68.2 | 100.2 |
| | [1322] | [94.1] | | | |
| Example 21 | 972 | 65.8 | 1.4 | 116.9 | 153.0 |
| | [1437] | [97.2] | | | |
| Example 22 | 928.0 | 62.9 | 1.4 | 123.3 | 143.9 |
| | [1715.1] | [116.2] | | | |
| Example 23 | 650.7 | 56.1 | 1.4 | 55.2 | 67 |
| | [1184.0] | [102.3] | | | |

As can be seen from Table 4 above, compared to Comparative Example 7, which used a commercialized resin infusion resin composition, Examples 19 to 23, which applied the thermosetting resin composition of the present disclosure, showed 74-108% tensile strength, 86-106% tensile modulus, and an equivalent level of elongation. In particular, Examples 20 to 22, which were prepared using resin compositions with DVS and TMPTA as crosslinking agents, showed improved heat resistance and equal or better mechanical strength compared to composites based on commercial resins.

### Experimental Example 4: Evaluation of Self-Healing Performance of Resin Composition

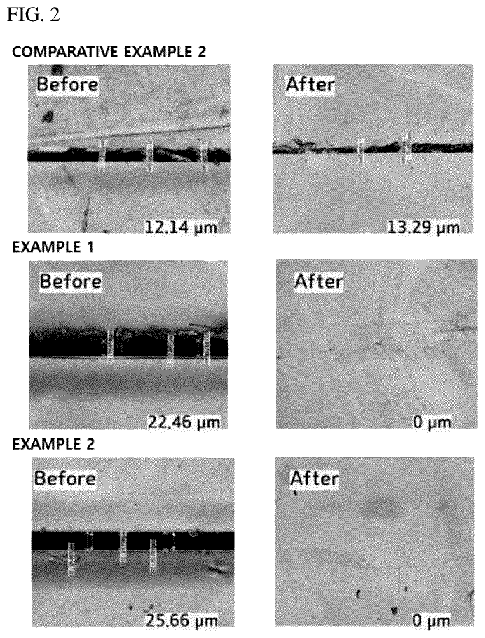

The self-healing performance of the thermosetting resin composition according to the present disclosure was evaluated. Scratches were created on the surface of cured specimens of Example 1, Example 2, and Comparative Example 2 compositions using a blade, the scratched specimens were fixed between a hot press, heated at 180° C. for 1 hour, and then the surface was photographed, with the results shown in FIG. 2.

As can be seen from FIG. 2, in the case of existing commercial resin compositions, scratches do not heal even when heat is applied, but in the case of the thermosetting resin composition according to the present disclosure, scratches heal even without any pressure for bonding when heat above the glass transition temperature is applied. This can be attributed to the dynamic crosslinks in the polymer included in the thermosetting resin composition, and it can be expected that applying this to other thermosetting resin application materials would not only increase convenience in maintaining consumer products but also have a positive impact from an environmental friendliness perspective.

### Experimental Example 5: Evaluation of Decomposability of Composites

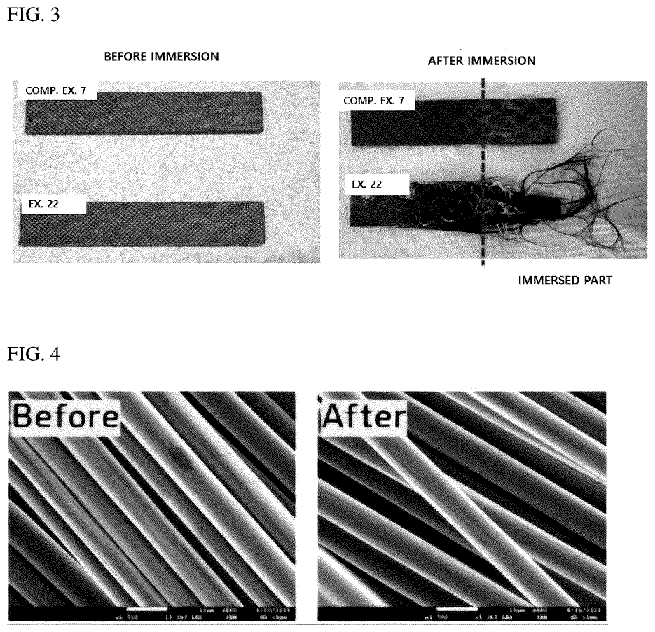

To evaluate the decomposability of carbon fiber reinforced composites according to the present disclosure, parts of the composite specimens according to Example 22 and Comparative Example 7 were immersed in 30-35% H₂O₂ aqueous solution at 100° C. for 8 hours to observe changes, and SEM images were taken of the carbon fiber fabric surface before composite manufacturing and of the carbon fiber fabric recovered after decomposition, with the results shown in FIGS. 3 and 4.

As can be seen from FIG. 3, when immersed in an environmentally friendly oxidizing agent, H₂O₂ aqueous solution, it was confirmed that the carbon fiber reinforced composite according to the present disclosure undergoes a chemical decomposition reaction, indicating that the carbon fibers can be recycled.

Also, as can be seen from FIG. 4, unlike those manufactured with commercial epoxy resin compositions, it was confirmed that the carbon fiber fabric obtained after the chemical decomposition reaction showed quality equivalent to virgin materials.

The features, structures, effects, and the like described in the example embodiments above are included in at least one embodiment of the present disclosure and are not necessarily limited to a single embodiment. Furthermore, the features, structures, effects, and the like in each example embodiment can be combined or modified in other embodiments by those having ordinary skill in the art to which the embodiments pertain. Therefore, such combinations and modifications should be construed as being within the scope of the present disclosure.

What is claimed is:

1. A thermosetting resin composition comprising:
a polymer formed by reacting an epoxy resin, an amine-based compound, and a crosslinking agent,
wherein the epoxy resin is represented by Chemical Formula 1,
the amine-based compound includes at least one primary amine group, and
the crosslinking agent includes an acrylate-based compound, a vinyl-based compound, or any combination thereof: 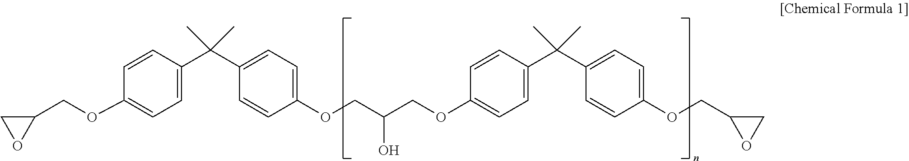
wherein in Chemical Formula 1, n represents an average number of repeating units and satisfies 0<n≤0.6.

2. The thermosetting resin composition of claim 1, wherein the amine-based compound comprises 4,4′-methylene bis(2-methylcyclohexylamine), 4,4′-methylene bis(cyclohexylamine), diethylene triamine, isophorone diamine, 4,4′-diaminophenylsulfone, diethyltoluene diamine, triethylene tetramine, dicyandiamide, or any combination thereof.

3. The thermosetting resin composition of claim 1, wherein the acrylate-based compound is represented by Chemical Formula 2: 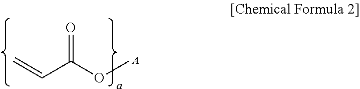
wherein in Chemical Formula 2, A is a substituted C1-C10 linear alkyl group or an unsubstituted C1-C10 linear alkyl group or a substituted C3-C10 branched alkyl group or an unsubstituted C3-C10 branched alkyl group, a substituted C2-C10 linear alkyl group including an ether group or an unsubstituted C2-C10 linear alkyl group including an ether group or a substituted C3-C10 branched alkyl group including an ether group or an unsubstituted C3-C10 branched alkyl group including an ether group, a substituted C3-C10 cyclic alkyl group or an unsubstituted C3-C10 cyclic alkyl group, a substituted C6-C20 aryl group or an unsubstituted C6-C20 aryl group, or any combination thereof, and a is in a range of from 2 to 10.

4. The thermosetting resin composition of claim 1, wherein the vinyl-based compound is represented by Chemical Formula 3: 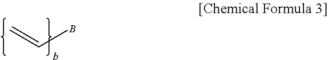
wherein in Chemical Formula 3, B is a substituted C1-C10 linear alkyl group or an unsubstituted C1-C10 linear alkyl group or a substituted C3-C10 branched alkyl group or an unsubstituted C3-C10 branched alkyl group, a substituted C2-C10 linear alkyl group including an ether group or an unsubstituted C2-C10 linear alkyl group including an ether group or a substituted C3-C10 branched alkyl group including an ether group or an unsubstituted C3-C10 branched alkyl group including an ether group, a substituted C3-C10 cyclic alkyl group or an unsubstituted C3-C10 cyclic alkyl group, a substituted C6-C20 aryl group or an unsubstituted C6-C20 aryl group, a sulfone group, a sulfonate group, a sulfide group, or any combination thereof, and b is in a range of from 2 to 10.

5. The thermosetting resin composition of claim 1, wherein the polymer is formed by reacting the epoxy resin, the amine-based compound, and the crosslinking agent in a molar ratio in a range of 1:(0.5 to 2):(0.3 to 2).

6. The thermosetting resin composition of claim 1, wherein the polymer comprises a crosslinked network.

7. The thermosetting resin composition of claim 6, wherein formation and decomposition of the crosslinked network is reversible.

8. The thermosetting resin composition of claim 1, wherein the thermosetting resin composition has a stress relaxation time (RT180° C.) at 180° C. of 3000 seconds or less.

9. The thermosetting resin composition of claim 1, wherein the thermosetting resin composition has a glass transition temperature (Tg) of 50° C. or higher.

10. A method for manufacturing a thermosetting resin composition, the method comprising:
preparing a mixture by mixing an epoxy resin and a crosslinking agent; and
adding an amine-based compound to the mixture.

11. The method of claim 10, wherein adding comprises adding the amine-based compound to the mixture in a single addition or in a plurality of additions.

12. A carbon fiber reinforced composite comprising:
the thermosetting resin composition of claim 1; and
carbon fibers.

13. The thermosetting resin composition of claim 12, wherein the amine-based compound comprises 4,4′-methylene bis(2-methylcyclohexylamine), 4,4′-methylene bis(cyclohexylamine), diethylene triamine, isophorone diamine, 4,4′-diaminophenylsulfone, diethyltoluene diamine, triethylene tetramine, dicyandiamide, or any combination thereof.

14. The thermosetting resin composition of claim 12, wherein the acrylate-based compound is represented by Chemical Formula 2: 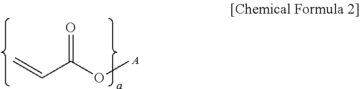
wherein in Chemical Formula 2, A is a substituted C1-C10 linear alkyl group or an unsubstituted C1-C10 linear alkyl group or a substituted C3-C10 branched alkyl group or an unsubstituted C3-C10 branched alkyl group, a substituted C2-C10 linear alkyl group including an ether group or an unsubstituted C2-C10 linear alkyl group including an ether group or a substituted C3-C10 branched alkyl group including an ether group or an unsubstituted C3-C10 branched alkyl group including an ether group, a substituted C3-C10 cyclic alkyl group or an unsubstituted C3-C10 cyclic alkyl group, a substituted C6-C20 aryl group or an unsubstituted C6-C20 aryl group, or any combination thereof, and a is in a range of from 2 to 10.

15. The thermosetting resin composition of claim 12, wherein the vinyl-based compound is represented by Chemical Formula 3: 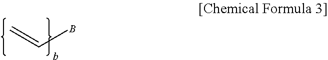
wherein in Chemical Formula 3, B is a substituted C1-C10 linear alkyl group or an unsubstituted C1-C10 linear alkyl group or a substituted C3-C10 branched alkyl group or an unsubstituted C3-C10 branched alkyl group, a substituted C2-C10 linear alkyl group including an ether group or an unsubstituted C2-C10 linear alkyl group including an ether group or a substituted C3-C10 branched alkyl group including an ether group or an unsubstituted C3-C10 branched alkyl group including an ether group, a substituted C3-C10 cyclic alkyl group or an unsubstituted C3-C10 cyclic alkyl group, a substituted C6-C20 aryl group or an unsubstituted C6-C20 aryl group, a sulfone group, a sulfonate group, a sulfide group, or any combination thereof, and b is in a range of from 2 to 10.

16. The thermosetting resin composition of claim 12, wherein the polymer is formed by reacting the epoxy resin, the amine-based compound, and the crosslinking agent in a molar ratio in a range of 1:(0.5 to 2):(0.3 to 2).

17. The thermosetting resin composition of claim 12, wherein the polymer comprises a crosslinked network.

18. The thermosetting resin composition of claim 17, wherein formation and decomposition of the crosslinked network is reversible.

19. The thermosetting resin composition of claim 12, wherein the thermosetting resin composition has a stress relaxation time (RT180° C.) at 180° C. of 3000 seconds or less.

20. The thermosetting resin composition of claim 12, wherein the thermosetting resin composition has a glass transition temperature (Tg) of 50° C. or higher.
